(19) United States
(12) Patent Application Publication
(10) Pub. No.: US 2018/0345687 A1
(43) Pub. Date: Dec. 6, 2018

(54) PRINTING APPARATUS

(71) Applicant: SEIKO EPSON CORPORATION, Tokyo (JP)

(72) Inventors: Yoshitsugu TOKAI, Shen Zhen City (CN); Hiroki AOKI, Matsumoto (JP); Takehito WASHIZAWA, Shiojiri (JP)

(21) Appl. No.: 15/997,296

(22) Filed: Jun. 4, 2018

(30) Foreign Application Priority Data
Jun. 5, 2017 (JP) 2017-110659

(51) Int. Cl. B41J 11/00

(52) U.S. Cl. CPC B41J 11/0095; B41J 11/007

(57) ABSTRACT

A printing apparatus includes a transport unit that transports a medium in a transport direction by rotating while pinching the medium, a support portion that is disposed on a downstream side of the transport unit in the transport direction and that has a support surface that supports the medium transported by the transport unit, a printing unit that is disposed opposite the support portion and that is capable of printing an image and a mark on the medium, and a detection unit that detects the mark printed on the medium by the printing unit when printing on both surfaces of the medium is performed, where the detection unit is disposed on a downstream side of the transport unit in the transport direction.

### BACKGROUND

### 1. Technical Field

The present invention relates to a printing apparatus such as an ink jet printer.

### 2. Related Art

An example of a printing apparatus is a printer that prints an image on the rear surface of a medium in accordance with the position of an image printed on the front surface of the medium when printing on both the front surface and rear surface of the medium. JP-A-2010-12757 describes a printer that, by detecting a mark printed on the front surface of a medium separately from an image, prints an image on the rear surface of the medium in such a manner that it overlaps with the image printed on the front surface of the medium.

In the printer described in JP-A-2010-12757, when an image is to be printed on the rear surface of the medium, there is a possibility that a sensor cannot accurately detect the mark if the medium is bent or tilted. If the accuracy of detection of the mark by the sensor deteriorates, there is a possibility that the image cannot be printed on the rear surface of the medium in accordance with the position of the image printed on the front surface of the medium.

### SUMMARY

An advantage of some aspects of the invention is that a printing apparatus capable of accurately detecting a mark printed on a medium is provided.

An aspect of the invention and advantages thereof will be described.

A printing apparatus according to an aspect of the invention that solves the above problem includes a transport unit that transports a medium in a transport direction by rotating while pinching the medium, a support portion that is disposed on a downstream side of the transport unit in the transport direction and that has a support surface that supports the medium transported by the transport unit, a printing unit that is disposed opposite the support portion and that is capable of printing an image and a mark on the medium, and a detection unit that detects the mark printed on the medium by the printing unit when printing on both surfaces of the medium is performed, where the detection unit is disposed on a downstream side of the transport unit in the transport direction.

Because the detection unit is positioned on the downstream side of the transport unit in the transport direction, when printing images on both sides of the medium, the detection unit detects the mark printed on the medium pinched by the transport unit. The medium is pinched by the transport unit so that its posture is kept stable. That is, according to the above configuration, the detection unit can detect the mark printed on the medium in a state where the posture of the medium is stably maintained by the medium being pinched by the transport unit. Therefore, the mark printed on the medium can be accurately detected.

In the printing apparatus according to the aspect, the detection unit may be disposed on the upstream side of the printing unit in the transport direction.

According to this configuration, because the printing unit prints the image on the medium after the detection unit has detected the mark, the throughput of the printing apparatus can be improved.

In the printing apparatus according to the aspect, the detection unit may be disposed at a position overlapping with the support portion in the transport direction and the mark of the medium can be detected through an opening provided in the support surface of the support portion.

According to this configuration, the detection unit can detect the mark printed on the medium supported by the support surface of the support portion. Therefore, the accuracy of detection of the mark by the detection unit can be improved.

The printing apparatus according to the aspect may further include a heating unit for heating the support surface of the support portion, where the detection unit is disposed on an upstream side of the heating unit in the transport direction.

According to this configuration, the detection unit can detect the mark printed on the medium before the medium supported on the support surface of the support portion becomes elongated due to heating of the heating unit. Therefore, the accuracy of detection of the mark by the detection unit can be improved.

In the printing apparatus according to the aspect, the support surface may extend horizontally.

According to this configuration, the detection unit can detect the mark printed on the medium supported by the support surface of the support portion. Therefore, the accuracy of detection of the mark by the detection unit can be improved.

### BRIEF DESCRIPTION OF THE DRAWINGS

The invention will be described with reference to the accompanying drawings, wherein like numbers reference like elements.

FIG. 1 is a side view schematically illustrating an embodiment of a printing apparatus.

FIG. 2 is a plan view schematically illustrating a structure inside a housing.

FIG. 3 is a plan view illustrating a front surface of a medium on which an image and a mark are printed.

FIG. 4 is a side view of when an image is being printed on the front surface of the medium.

FIG. 5 is a side view of when an image is being printed on a rear surface of the medium.

### DESCRIPTION OF EXEMPLARY EMBODIMENTS

Hereinafter, an embodiment of a printing apparatus will be described with reference to the drawings.

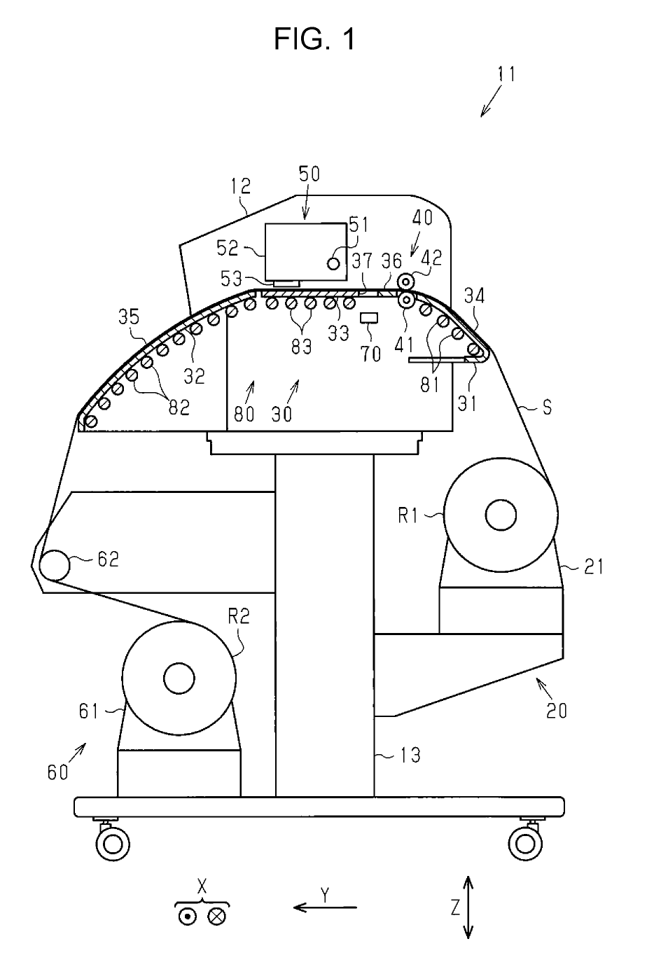

As illustrated in FIG. 1, a printing apparatus 11 includes a housing 12 and a leg portion 13 that supports the housing 12. The printing apparatus 11 includes a feeding unit 20 that feeds out a medium S from the outside of the housing 12 to the inside of the housing 12, and a medium support unit 30 that supports the medium S fed out from the feeding unit 20. The printing apparatus 11 includes a transport unit 40 that transports the medium S in a transport direction Y along the medium support unit 30. The printing apparatus 11 includes a printing mechanism 50 for printing images such as characters, photographs and the like on the medium S, and a winding unit 60 for taking up the medium S that has been printed on by the printing mechanism 50. The medium support unit 30, the transport unit 40, and the printing mechanism 50 are attached to the housing 12.

The feeding unit 20 is disposed outside the housing 12 and is attached to the leg portion 13. The feeding unit 20 has a holder 21 that detachably holds a roll body R1 on which the medium S is wound in a roll shape. The feeding unit 20 unwinds the medium S from the roll body R1 by rotating the roll body R1 attached to the holder 21. In this embodiment, the feeding unit 20 feeds the medium S by rotating the roll body R1 held by the holder 21 counterclockwise in FIG. 1. In this embodiment, the medium S is paper.

The medium support unit 30 is provided across the inside and outside of the housing 12. The medium support unit 30 has a first guide portion 31, a second guide portion 32, and a support portion 33, each of which is formed of a plate-like member. The first guide portion 31 is provided from the outside of the housing 12 to the inside of the housing 12 and supports the medium S so as to guide the medium S fed out from the feeding unit 20 toward the inside of the housing 12. The support portion 33 is provided in the housing 12 and supports the medium S guided by the first guide portion 31. The second guide portion 32 is provided from the inside of the housing 12 to the outside of the housing 12 and supports the medium S so as to guide the medium S passing over the support portion 33 toward the outside of the housing 12. That is, the first guide portion 31 is disposed on the upstream side of the support portion 33 in the transport direction Y in which the medium S is transported. The second guide portion 32 is disposed on the downstream side of the support portion 33 in the transport direction Y.

The upper surfaces of the first guide portion 31 and the second guide portion 32 are respectively a guide surface 34 and a guide surface 35 for guiding the medium S. The support portion 33 has a support surface 36 on the upper surface thereof that supports the medium S. The support surface 36 in this embodiment extends horizontally. In this embodiment, the transport direction Y in which the medium S is transported refers to the direction in which the medium S moves on the support surface 36 of the support portion 33 through the driving of the transport unit 40. In this embodiment, the first guide portion 31 and the second guide portion 32 are configured so that the guide surface 34 and the guide surface 35 are curved with respect to the transport direction Y, respectively. In the support portion 33, a hole 37 is provided as an opening in the support surface 36. That is, the hole 37 extends from the upper surface to the lower surface of the support portion 33 and passes through the support portion 33 in the vertical direction Z. The hole 37 is provided in the support surface 36 at a position that is closer to the upstream side in the transport direction Y and is configured to expose a portion of the lower surface of the medium S transported on the support surface 36 from below the support portion 33.

The transport unit 40 is provided in the housing 12 and is disposed at a position between the first guide portion 31 and the support portion 33 in the transport direction Y. That is, the transport unit 40 is disposed on the upstream side of the support portion 33 in the transport direction Y. The transport unit 40 has a driving roller 41 capable of driving rotation and a driven roller 42 capable of being driven to rotate with respect to the rotation of the driving roller 41. The driving roller 41 is, for example, connected to a driving source such as a motor and rotates by the driving force of the driving source. The transport unit 40 transports the medium S in the transport direction Y by rotation of the driving roller 41 and the driven roller 42 with the medium S pinched therebetween. In this embodiment, the driving roller 41 can come in contact with the medium S from below in the vertical direction Z. The driven roller 42 can come in contact with the medium S from above in the vertical direction Z.

The printing mechanism 50 is provided in the housing 12 and is arranged so as to face the support portion 33. In this embodiment, the printing mechanism 50 is disposed above the support portion 33 in the vertical direction Z, and is disposed at a position that is closer to the downstream side in the transport direction Y in a region facing the support portion 33. The printing mechanism 50 has a guide shaft 51 extending in the width direction X of the medium S, a mobile body 52 supported by the guide shaft 51, and a printing unit 53 mounted on the mobile body 52.

The mobile body 52 is movable along the guide shaft 51. That is, the mobile body 52 is configured to be movable in the width direction X. The printing unit 53 is capable of ejecting a liquid such as ink, for example, toward the support portion 33 that faces the printing unit 53. The printing unit 53 prints an image on the medium S by ejecting the liquid onto the medium S supported by the support portion 33. The printing unit 53, through movement of the mobile body 52 in the width direction X, is capable of printing across the width direction X of the medium S transported in the transport direction Y. The printing unit 53 in this embodiment is positioned so as to face a portion of the support portion 33 that is closer to the downstream side in the transport direction Y.

The printing apparatus 11 according to this embodiment is usually used while installed on a floor surface that is horizontal. In the printing apparatus 11 of this embodiment, the floor surface on which the printing apparatus 11 is installed and the support surface 36 of the support portion 33 are configured to be substantially parallel to each other. Therefore, when considering a coordinate system consisting of three axes orthogonal to each other, the X axis, Y axis, and Z axis, if the coordinate axes are set so that the Z axis extends in the vertical direction Z, the horizontal floor surface is a plane extending along the X axis and the Y axis. That is, the support surface 36 of the support portion 33 is a plane extending along the X axis and the Y axis.

Next, the vertical direction Z and the extending direction of the Z axis coincide with each other, and the coordinate axes are set so that the X axis extends along the guide shaft 51, that is, extends in the width direction X. In the printing apparatus 11 of this embodiment, the direction in which the Y axis extends coincides with the transport direction Y. The X axis extending in the width direction X, the Y axis extending in the transport direction Y, and the Z axis extending in the vertical direction Z are in a relationship in which they are orthogonal to each other. That is, in this embodiment, the width direction X, the transport direction Y, and the vertical direction Z respectively indicate three different directions.

The winding unit 60 is disposed outside the housing 12 and is attached to the leg portion 13. The winding unit 60 includes a holder 61 that detachably holds a roll body R2 in which the medium S is wound in a roll shape and a tension bar 62 that applies tension to the medium S when winding the medium S. The roll body R2 is formed by winding up, by using the winding unit 60, the medium S on which an image has been printed by the printing unit 53. In this embodiment, the winding unit 60 winds the medium S wound around the tension bar 62 by rotating the roll body R2 held by the holder 61 in the clockwise direction in FIG. 1.

The printing apparatus 11 includes a detection unit 70 and a heating mechanism 80. The detection unit 70 is disposed in the housing 12 and is constituted by, for example, an optical sensor. The detection unit 70 is disposed at a position overlapping with the support portion 33 in the transport direction Y. That is, the detection unit 70 is disposed on the downstream side of the transport unit 40 in the transport direction Y. The detection unit 70 is disposed below the support portion 33 in the vertical direction Z. The detection unit 70 in this embodiment is located right under the hole 37 of the support portion 33. The detection unit 70 is disposed at a position so as to be exposed through the hole 37 of the support portion 33 when the support portion 33 is viewed from above, that is, at a position overlapping with the hole 37 in the vertical direction Z. Further, the detection unit 70 functions when the printing apparatus 11 executes duplex printing in which images are printed on both surfaces of the medium S.

The hole 37 of the support portion 33 is on the upstream side of the printing unit 53 in the transport direction Y. The hole 37 in this embodiment is positioned on the upstream side of the printing mechanism 50. That is, the detection unit 70 arranged so as to correspond to the hole 37 of the support portion 33 is disposed on the upstream side of the printing unit 53 in the transport direction Y.

The heating mechanism 80 is provided along the medium support unit 30, and is disposed below the medium support unit 30. The heating mechanism 80 includes an upstream heating unit 81 attached to the lower surface of the first guide portion 31, a downstream heating unit 82 attached to the lower surface of the second guide portion 32, and a heating unit 83 attached to the lower surface of the support portion 33. That is, the upstream heating unit 81 is located on the upstream side of the heating unit 83 in the transport direction Y. The downstream heating unit 82 is located on the downstream side of the heating unit 83 in the transport direction Y. The heating mechanism 80 indirectly heats the medium S supported by the medium support unit 30 by heating the medium support unit 30.

The upstream heating unit 81 heats the guide surface 34, which is the upper surface of the first guide portion 31, from the lower surface of the first guide portion 31. The downstream heating unit 82 heats the guide surface 35, which is the upper surface of the second guide portion 32, from the lower surface of the second guide portion 32. The heating unit 83 heats the support surface 36, which is the upper surface of the support portion 33, from the lower surface of the support portion 33. The medium S supported by the medium support unit 30 is heated by the heating mechanism 80 via the guide surface 34, the guide surface 35, and the support surface 36. The upstream heating unit 81, the downstream heating unit 82, and the heating unit 83 are each formed of, for example, a tube heater, and are arranged on the lower surfaces of the first guide portion 31, the second guide portion 32, and the support portion 33, respectively.

The upstream heating unit 81 heats the medium S before the medium S is printed on by the printing mechanism 50. Therefore, the upstream heating unit 81 functions as a so-called preheater and heats the medium S before printing in advance, thereby promoting the evaporation of the liquid ejected from the printing unit 53 onto the medium S. Further, note that the temperature of the upstream heating unit 81 is set to be lower than that of the downstream heating unit 82 and the heating unit 83 so as not to excessively heat the medium S.

The heating unit 83 heats the medium S being printed on by the printing mechanism 50. Therefore, the heating unit 83, by promoting the evaporation of the liquid ejected from the printing unit 53 onto the medium S, suppresses bleeding of the image printed on the medium S. Further, it should be noted that the heating unit 83 is provided only at a portion of the support portion 33 on the downstream side of the position where the hole 37 is provided in the transport direction Y.

The downstream heating unit 82 heats the medium S that has been printed on by the printing mechanism 50. Therefore, the downstream heating unit 82 functions as a so-called afterheater, and heating the medium S after printing has been performed promotes the evaporation of the liquid adhered to the medium S and promotes fixing of the image that has been printed on the medium S.

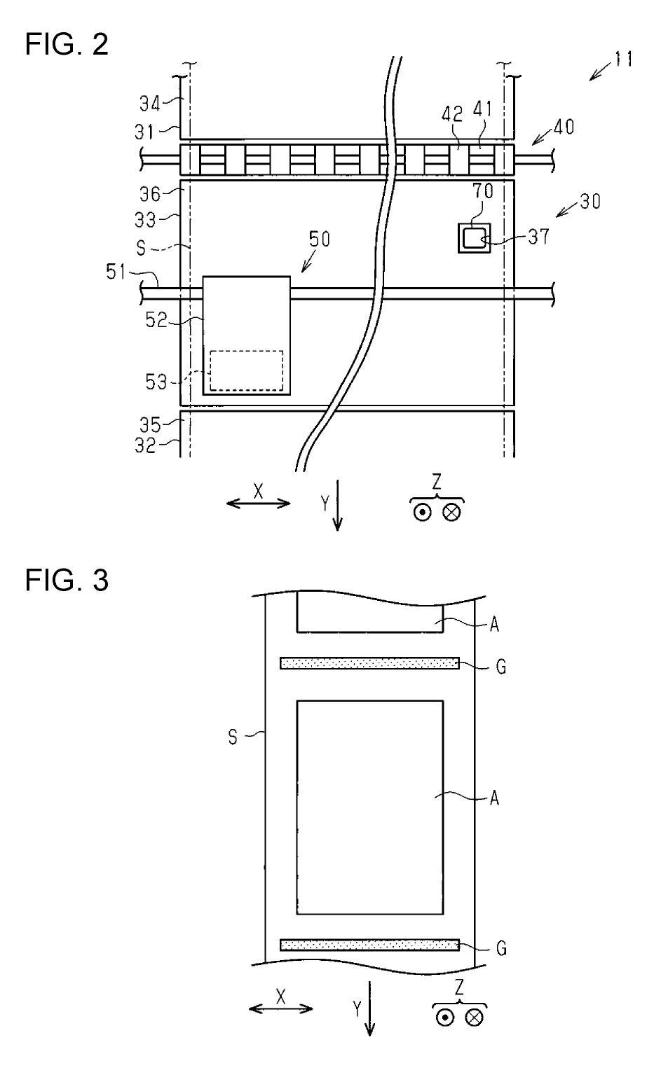

As illustrated in FIG. 2, assuming that the right end of the support portion 33 is a first end and the left end is a second end in FIG. 2, the hole 37 of the support portion 33 opens at a position that is closer to the first end than the center position of the support surface 36 in the width direction X. When transporting the medium S, the printing apparatus 11 according to this embodiment transports the medium S such that the right end of the medium S on the right side in FIG. 2 is aligned with the first end side of the support portion 33. Therefore, even in the case where the printing apparatus 11 transports the smallest-size printable medium S or the maximum-size printable medium S, the medium S moves on the support surface 36 so as to pass directly above the hole 37. Further, in the case where the medium S is transported so that the center position of the support surface 36 and the center position of the medium S are aligned in the width direction X, the hole 37 is preferably provided at a position that is close to the center of the support surface 36 in the width direction X.

The printing apparatus 11 is capable of printing images on both sides of the medium S. When printing on both sides of the medium S, the printing apparatus 11 according to this embodiment, first, prints an image on the front surface of the medium S fed out from the roll body R1 mounted on the feeding unit 20. Next, the printing apparatus 11 via a monitor, an alarm, or the like, prompts the user to detach the roll body R2, which is formed by the winding unit 60 winding up the medium S that has had an image printed on the surface thereof, from the winding unit 60 and to attach the roll body R2 to the feeding unit 20. At this time, the roll body R2 is wound in a roll shape so that the rear surface opposite to the surface on which an image has been printed corresponds to the outer circumference surface of the roll body R2. Consequently, when the roll body R2 mounted on the feeding unit 20 is rotated counterclockwise in FIG. 1, the medium S is fed out from the feeding unit 20 so that the rear surface of the medium S faces the printing mechanism 50 above the support surface 36. Next, the printing apparatus 11 prints an image on the rear surface of the medium S fed out from the roll body R2 mounted on the feeding unit 20. As a result, the printing apparatus 11 prints images on both sides of the medium S.

When duplex printing is performed on the medium S, the printing apparatus 11 sometimes prints an image on the rear surface of the medium S in accordance with the position of the image printed on the front surface of the medium S. In order to achieve this, the printing apparatus 11 is configured so as to be capable of printing marks G (refer to FIG. 3) for detecting the position of the image printed on the front surface of the medium S.

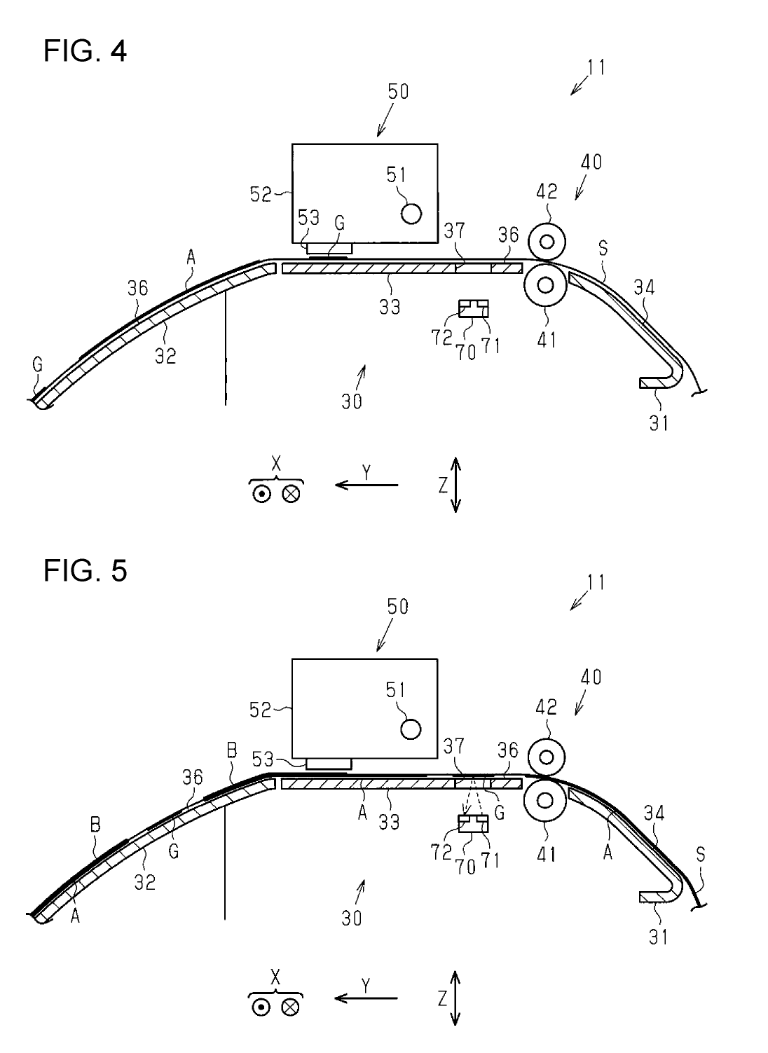

As illustrated in FIGS. 3 and 4, the printing unit 53, in the case of printing an image on both surfaces of the medium S, prints marks G separately from the image on the front surface of the medium S. Further, for convenience of explanation, in this embodiment, an image to be printed on the front surface of the medium S is referred to as an image A and an image to be printed on the rear surface of the medium S is referred to as an image B. The printing apparatus 11 according to this embodiment prints belt-like marks G extending in the width direction X before and after printing the image A on the surface of the medium S. That is, the marks G are positioned so as to pinch the image A in the transport direction Y on the surface of the medium S. The marks G are printed at a predetermined interval with respect to the image A in the transport direction Y. When printing a plurality of images A on the medium S, the printing apparatus 11 alternately prints the mark G and the image A on the surface of the medium S.

As illustrated in FIG. 5, when the medium S is fed out from the feeding unit 20 so as to print the image B on the rear surface of the medium S, the detection unit 70 detects the mark G printed on the front surface of the medium S transported on the support surface 36 via the hole 37 of the support portion 33. At this time, the medium S is transported in a posture in which the surface on which the image A and the marks G are printed faces the support surface 36 of the support portion 33.

The detection unit 70 has a light projecting element 71 for irradiating light and a light receiving element 72 for receiving light. The detection unit 70 is configured so that the light projecting element 71 irradiates light toward the hole 37 of the support portion 33 and the light from the light projecting element 71 reflected by the medium S is received by the light receiving element 72 as indicated by a broken line in FIG. 5. The detection unit 70 detects the mark G printed on the medium S based on the intensity of the light received by the light receiving element 72. That is, the mark G is printed on the surface of the medium S at a position that can be detected by the detection unit 70 via the hole 37 of the support portion 33.

The printing apparatus 11, by detecting the mark G by the detection unit 70, calculates the position of the image A printed on the surface of the medium S with reference to the position of the mark G. That is, the printing apparatus 11 detects the position of the image A based on the detection of the mark G by the detection unit 70. The printing apparatus 11 according to this embodiment calculates the position of the image A located on the upstream side of the mark G in the transport direction Y with reference to the position of the mark G detected by the detection unit 70. The printing apparatus 11 prints the image B on the rear surface of the medium S based on the position of the image A on the front surface of the medium S. In this embodiment, the printing apparatus 11, when executing duplex printing, prints the image B so as to overlap with the image A on the front surface of the medium S.

Next, the operation of the printing apparatus 11 configured as described above will be described.

In the case where the image B is printed on the rear surface of the medium S based on the position of the image A printed on the front surface of the medium S, the accuracy of detection of the mark G by the detection unit 70 becomes important. For example, when the detection unit 70 detects the mark G, if the medium S is bent or tilted, the distance between the medium S and the detection unit 70 changes, and there is a possibility that the accuracy of detection of the mark G by the detection unit 70 will decrease. For example, there is a possibility that the medium S positioned on the first guide portion 31 may be lifted off the guide surface 34 by feeding out of the feeding unit 20. Therefore, in the case where the detection unit 70 is disposed on the upstream side of the transport unit 40 in the transport direction Y and is configured to detect the medium S on the first guide portion 31, there is a possibility that the detection unit 70 may not be able to detect the mark G with high accuracy. In this respect, in the printing apparatus 11 according to this embodiment, the detection unit 70 is arranged on the downstream side of the transport unit 40 in the transport direction Y.

The medium S is pinched between the driving roller 41 and the driven roller 42 constituting the transport unit 40, so that its posture is kept stable. That is, the detection unit 70 detects the mark G printed on the medium S while the posture is stably maintained by being pinched by the transport unit 40. Therefore, the detection unit 70 can detect the mark G with high accuracy. In particular, in this embodiment, because the detection unit 70 detects the mark G of the medium S horizontally supported by the support portion 33, the accuracy of detection of the detection unit 70 is further improved.

Normally, the printing apparatus 11 such as that described above prints an image on the medium S while stably supporting the medium S in order to improve the image quality of the image. The printing apparatus 11 according to this embodiment is configured so that the posture of the medium S when the detection unit 70 detects the mark G corresponds to the posture of the medium S at the time of printing the image. Therefore, the detection unit 70 can detect the mark G more accurately.

According to the above embodiment, the following effects can be obtained.

(1) Because the detection unit 70 is positioned downstream of the transport unit 40 in the transport direction Y, when an image is printed on both surfaces of the medium S, the detection unit 70 detects the mark G printed on the medium S pinched by the transport unit 40. The medium S is pinched by the transport unit 40, so that its posture is kept stable. That is, the detection unit 70 can detect the mark G printed on the medium S while the posture of the medium S is stably maintained by the medium S being pinched by the transport unit 40. Therefore, the mark G printed on the medium S can be accurately detected.

(2) The detection unit 70 is disposed on the upstream side of the printing unit 53 in the transport direction Y. That is, because the printing unit 53 prints an image on the medium S after the detection unit 70 has detected the mark G, the throughput of the printing apparatus 11 can be improved.

(3) The detection unit 70 is disposed at a position overlapping with the support portion 33 in the transport direction Y, and is capable of detecting the mark G of the medium S through the hole 37 (opening) provided in the support surface 36 of the support portion 33. That is, the detection unit 70 can detect the mark G printed on the medium S supported by the support surface 36 of the support portion 33. Therefore, the accuracy of detection of the mark G by the detection unit 70 can be improved.

(4) The printing apparatus 11 includes the heating unit 83 that heats the support surface 36 of the support portion 33, and the detection unit 70 is disposed on the upstream side of the heating unit 83 in the transport direction Y. That is, the detection unit 70 can detect the mark G printed on the medium S before the medium S supported on the support surface 36 of the support portion 33 becomes elongated due to the heating of the heating unit 83. Therefore, the accuracy of detection of the mark G by the detection unit 70 can be improved.

(5) The support surface 36 of the support portion 33 extends horizontally. That is, the detection unit 70 can detect the mark G printed on the medium S supported horizontally by the support surface 36 of the support portion 33. Therefore, the accuracy of detection of the mark G by the detection unit 70 can be improved.

Further, the above embodiment may be modified as follows. In addition, the following modification examples may be appropriately combined.

The support surface 36 of the support portion 33 need not be horizontal. For example, the support surface 36 of the support portion 33 may be inclined with respect to the horizontal or may be curved.

The heating unit 83 may also be provided on a portion on the lower surface of the support portion 33 on the upstream side of the detection unit 70 in the transport direction Y.

A depression recessed downward from the support surface 36 of the support portion 33 may be provided as the opening of the support portion 33. In this case, by arranging the detection unit 70 in the depression, the detection unit 70 can detect the mark G.

The detection unit 70 may be disposed at a position on the downstream side of the printing unit 53 in the transport direction Y. In this case, the detection unit 70 is preferably disposed between the support portion 33 and the second guide portion 32. In addition, in this case, in order to suppress elongation of the medium S, the temperature of the heating unit 83 is preferably set lower than the temperature of the downstream heating unit 82.

The upper edge portion of the hole 37 that opens to the support surface 36 of the support portion 33 may be covered with a transparent cover such as glass or plastic. It is preferable that the cover have a degree of transparency that does not inhibit the detection of the mark G by the detection unit 70.

The mark G is not limited to a band shape but may be any shape as long as it can be detected by the detection unit 70. In addition, it suffices that the mark G is in a format that can be detected by the detection unit 70, and it may be, for example, a bar code through which information can be read by the detection unit 70.

The detection unit 70 is not limited to a reflective optical sensor as in this embodiment. For example, a transmissive optical sensor in which the light projecting element 71 and the light receiving element 72 are arranged so as to pinch the support portion 33 in the vertical direction Z may be used.

The printing apparatus 11 is not limited to a configuration in which the image A and the image B are printed so as to overlap on the front and rear surfaces of the medium S when duplex printing is performed. For example, the image B may be printed on the rear surface of the medium S so as to be shifted from the image A printed on the surface of the medium S by a predetermined distance.

The support portion 33 may have a suction mechanism for sucking the medium S toward the support surface 36. The medium S is not limited to continuous paper delivered from the roll body R1, and may be a single cut sheet. In addition, the medium S is not limited to paper, and may be a plastic film, a metal film, cloth, or the like.

The printing apparatus 11 may include a duplex-printing path for, after the front surface of the medium S has been printed on by the printing unit 53, transporting the medium S toward the printing unit 53 after the posture of the medium S has been reversed so that the rear surface of the medium S faces the printing unit 53.

The printing mechanism 50 may be as a so-called line head that is provided so as to extend in the width direction X and be fixedly disposed in the housing 12.

The printing apparatus 11 may be a fluid ejecting apparatus that performs recording by ejecting or discharging a fluid other than ink (including a liquid, a liquid in which particles of a functional material are dispersed or mixed in a liquid, a fluid body like a gel, and a solid that can be ejected as a fluid). For example, a liquid body ejecting apparatus that performs recording by ejecting a liquid body in the form of a dispersion or a solution including a material such as an electrode material or a coloring material (pixel material) used for manufacturing a liquid crystal display, an EL (electroluminescence) display, a surface emitting display, or the like may be used. In addition, a fluid body ejecting apparatus that ejects a fluid body such as a gel (for example, a physical gel) or a particulate matter ejecting apparatus (for example, a toner jet recording apparatus) that ejects a solid exemplified by a powder (particulate matter) such as toner may be used. The invention can be applied to any one of the fluid ejecting apparatuses. Further, in this specification, the term “fluid” refers to, for example, a liquid (including an inorganic solvent, an organic solvent, a solution, a liquid resin, a liquid metal (metal melt) and the like), a liquid body, a fluid body, particulate matter (including grains and powder), and the like.

This application claims priority under 35 U.S.C. § 119 to Japanese Patent Application No. 2017-110659, filed Jun. 5, 2017. The entire disclosure of Japanese Patent Application No. 2017-110659 is hereby incorporated herein by reference.

What is claimed is:

1. A printing apparatus comprising:
a transport unit that transports a medium in a transport direction by rotating while pinching the medium,
a support portion that is disposed on a downstream side of the transport unit in the transport direction and that has a support surface that supports the medium transported by the transport unit,
a printing unit that is disposed opposite the support portion and that is capable of printing an image and a mark on the medium, and
a detection unit that detects the mark printed on the medium by the printing unit when printing on both surfaces of the medium is performed,
wherein the detection unit is disposed on a downstream side of the transport unit in the transport direction.

2. The printing apparatus according to claim 1, wherein the detection unit is disposed on an upstream side of the printing unit in the transport direction.

3. The printing apparatus according to claim 1, wherein the detection unit is disposed at a position overlapping with the support portion in the transport direction, and
wherein the mark of the medium can be detected through an opening provided in the support surface of the support portion.

4. The printing apparatus according to claim 1, further comprising:
a heating unit that heats the support surface of the support portion,
wherein the detection unit is disposed on an upstream side of the heating unit in the transport direction.

5. The printing apparatus according to claim 1, wherein the support surface extends horizontally.
